(19) United States
(12) Patent Application Publication
(10) Pub. No.: US 2025/0162020 A1
(43) Pub. Date: May 22, 2025

(54) METHOD OF EXTRACTING CHEMICAL SUBSTANCES FROM USED MOLDING SAND

(71) Applicant: National Pingtung University of Science and Technology, Pingtung County (TW)

(72) Inventors: Chia-Jung TSAI, Pingtung County (TW); Bo-Wei WU, Pingtung County (TW)

(73) Assignee: National Pingtung University of Science and Technology, Pingtung County (TW)

(21) Appl. No.: 18/948,917

(22) Filed: Nov. 15, 2024

(30) Foreign Application Priority Data
Nov. 21, 2023 (TW) 112144939

(51) Int. Cl. B22C 5/18; B08B 7/02

(52) U.S. Cl. CPC B22C 5/185; B08B 7/028

(57) ABSTRACT

A method of extracting chemical substances from used molding sand includes: preparing a mixture of used molding sand and liquid, wherein the used molding sand includes a sand material and at least one chemical substance; and cleaning the mixture via an ultrasonic cleaning process to separate and extract the at least one chemical substance from the sand material.

### CROSS-REFERENCE TO RELATED APPLICATION

This application claims priority to Taiwanese Invention patent application Ser. No. 11/214,4939, filed on Nov. 21, 2023, and incorporated by reference herein in its entirety.

### FIELD

The disclosure relates to a method of recycling molding sand, and more particularly to a method of extracting chemical substances from used molding sand.

### BACKGROUND

Molding sand is also known as foundry sand and is used for sand casting metal items. Molding sand is widely used in the metals and machinery tools industry and used molding sand from metal casting and dust collectors mainly contain silicon dioxide, aluminum oxide, and iron oxide.

In the past, used molding sand was discarded as a waste product and sent to landfills; however, when the sand material is separated from surface binding materials contained in the used molding sand, the sand material may be recycled and re-used. Additionally, chemical substances that are extracted from the recycling process may be used in other industries, for example, in soap manufacturing.

Conventionally, used molding sand is processed by washing with acid or washed and agitated in water. However, washing with acid causes pollution due to the use of chemicals, and washing and agitating in water cannot completely release the chemicals substances from the surface of the base foundry sand material.

### SUMMARY

Therefore, an object of the disclosure is to provide a method of extracting chemical substances from used molding sand that can alleviate at least one of the drawbacks of the prior art.

According to the disclosure, the method of extracting chemical substances from used molding sand includes: preparing a mixture of used molding sand and liquid, wherein the used molding sand includes a sand material and at least one chemical substance; and cleaning the mixture via an ultrasonic cleaning process to separate and extract the at least one chemical substance from the sand material.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating consecutive steps in an embodiment of a method of extracting chemical substances from used molding sand according to the present disclosure.

FIG. 2 is a graph comparing extraction rates using the method of the embodiment and a conventional method.

FIG. 3 is a graph showing the extraction rates of different batches using the method of the embodiment.

FIG. 4 is a photo comparing an uncleaned used molding sand before cleaning and a cleaned sand material after cleaning.

### DETAILED DESCRIPTION

Before the disclosure is described in greater detail, it should be

noted that where considered appropriate, reference numerals or terminal portions of reference numerals have been repeated among the figures to indicate corresponding or analogous elements, which may optionally have similar characteristics.

It should be noted herein that for clarity of description, spatially

relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

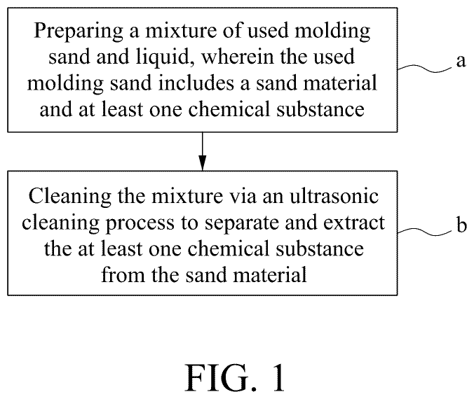

Referring to FIG. 1, an embodiment of a method of extracting chemical substances from used molding sand according to the present disclosure includes steps a) and b). In the step a) a mixture of used molding sand and liquid is prepared. The used molding sand includes a sand material and at least one chemical substance. In this embodiment, a volume ratio of the used molding sand to the liquid is 1:10 in the mixture.

Next, in the step b) the mixture is cleaned via an ultrasonic cleaning process to separate and extract the at least one chemical substance from the sand material. In this embodiment, the ultrasonic cleaning process uses a frequency that ranges from 30 KHz to 50 KHz, and the ultrasonic cleaning process operates at a power that ranges from 60 W to 80 W. The ultrasonic cleaning process uses an ultrasonic pulse to agitate the liquid and provide the cleaning effect. The ultrasonic pulse propagates through the liquid and induces the formation of captivation bubbles that burst upon contact with the used molding sand. The ultrasonic pulses further impact the used molding sand to remove impurities and cleanse the used molding sand.

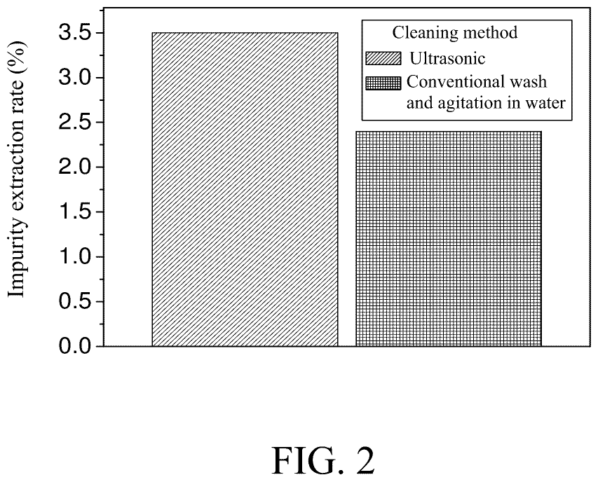

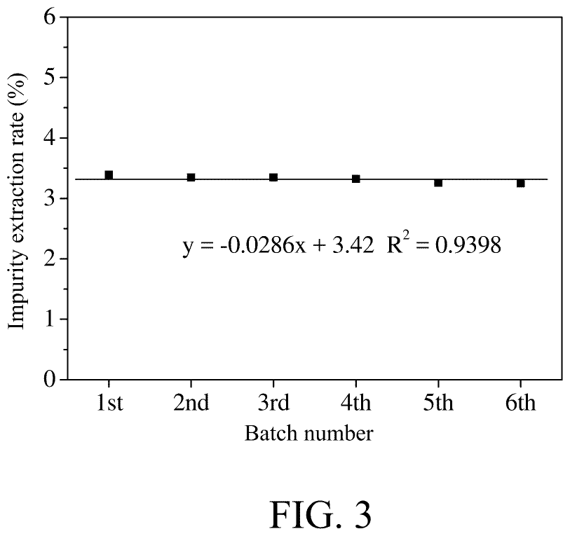

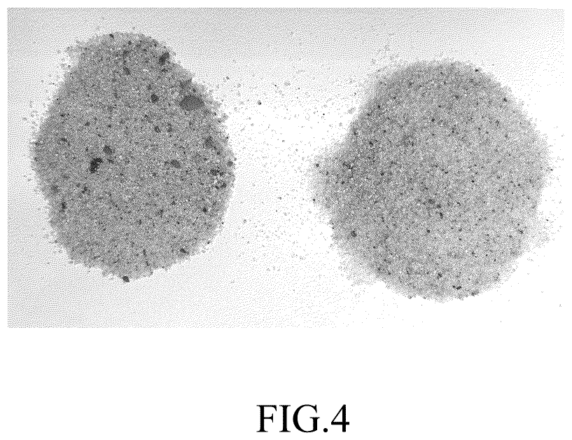

Referring to FIGS. 2 to 4, in the conventional method of processing used molding sand via washing and agitation in water, a volume ratio of the used molding sand to the liquid is 1:10, and the agitation is accomplished by a rotational stirring processes operated at a speed that ranges from 600 to 1000 RPM. After undergoing 20 hours of processing under the conventional method, an impurity extraction rate of 2% to 2.5% may be achieved. However, using the method according to the present disclosure an impurity extraction rate of 3% to 3.5% may be reached after only 3 hours. Referring to FIG. 2, in other words, the method of the present disclosure is 6.7 times more efficient compared to the conventional method in terms of time, and yields a 40% higher extraction rate of impurities. Referring to FIG. 3, a coefficient of determination R² is found to be 0.9398 using regression analysis of the impurity extraction rate yielded from various batches of used molding sand undergoing the method of the disclosure. This shows that the method of the present disclosure can consistently maintain the same impurity extraction rate or quality, and helps to illustrate that by employing the method of the disclosure, not only may a large amount of the chemical substance(s) be separated from the sand material, but also the sand material and the chemical substance(s) thus separated are of a higher quality that is more suitable for recycling. FIG. 4 shows the uncleaned used molding sand on the left side and the cleaned used molding sand after ultrasonic cleaning on the right side.

In summary of the above, the method of extracting chemical substances from used molding sand according to the present disclosure uses an ultrasonic cleaning process to separate and extract chemical substance(s) from the used molding sand material, provides high quality and consistent separation and extraction, separates out a large amount of the chemical substance(s), provides higher quality separated sand material and chemical substance(s) that are more suitable for recycling.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of extracting chemical substances from used molding sand comprising:
a) preparing a mixture of used molding sand and liquid, wherein the used molding sand includes a sand material and at least one chemical substance; and
b) cleaning the mixture via an ultrasonic cleaning process to separate and extract the at least one chemical substance from the sand material.

2. The method of extracting chemical substances from used molding sand as claimed in claim 1, wherein a volume ratio of the used molding sand to the liquid is 1:10 in the composite mixture.

3. The method of extracting chemical substances from molding sand as claimed in claim 1, wherein in the step b) of cleaning the mixture the ultrasonic cleaning process uses a frequency that ranges from 30 KHz to 50 KHz.

4. The method of extracting chemical substances from molding sand as claimed in claim 1, wherein in the step b) of cleaning the mixture the ultrasonic cleaning process operates at a power that ranges from 60 W to 80 W.
